(19) United States
(12) Patent Application Publication
(10) Pub. No.: US 2025/0149650 A1
(43) Pub. Date: May 8, 2025

(54) COMPOSITE INTERLAYER WITH HIGH LITHIUM SALT CONCENTRATION FOR LITHIUM METAL NEGATIVE ELECTRODES OF BATTERIES THAT CYCLE LITHIUM IONS AND METHODS OF MANUFACTURING THE SAME

(71) Applicant: GM GLOBAL TECHNOLOGY OPERATIONS LLC, Detroit, MI (US)

(72) Inventors: Xin ZHANG, Shanghai (CN); Zhe LI, Shanghai (CN); Haijing LIU, Shanghai (CN)

(21) Appl. No.: 18/519,759

(22) Filed: Nov. 27, 2023

(30) Foreign Application Priority Data
Nov. 8, 2023 (CN) 202311482392.5

(51) Int. Cl. H01M 10/42; H01M 4/02; H01M 4/134; H01M 4/38; H01M 10/052; H01M 10/0568; H01M 50/46

(52) U.S. Cl. CPC H01M 10/4235; H01M 4/134; H01M 4/382; H01M 10/052; H01M 10/0568; H01M 50/46; H01M 2004/027

(57) ABSTRACT

A battery that cycles lithium ions includes a lithium metal negative electrode, a positive electrode, a porous separator disposed between opposing facing surfaces of the lithium metal negative electrode and the positive electrode, and a composite interlayer disposed on the facing surface of the lithium metal negative electrode, between the lithium metal negative electrode and the porous separator. The composite interlayer includes a polymer matrix phase and a lithium salt distributed phase embedded in and distributed throughout the polymer matrix phase. The lithium salt distributed phase constitutes, by weight, greater than or equal to about 10% and less than or equal to about 50% of the composite interlayer.

### CROSS-REFERENCE TO RELATED APPLICATIONS

This application claims the benefit of Chinese Patent Application No. 202311482392.5, filed on Nov. 8, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to batteries that cycle lithium ions, and more particularly to composite interlayers for lithium metal negative electrodes of batteries that cycle lithium ions.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. A polymeric separator is oftentimes disposed between the positive and negative electrodes that physically separates and electrically isolates the positive and negative electrodes from each other while permitting lithium ions to pass therethrough. The positive and negative electrodes are oftentimes disposed as thin layers on surfaces of respective positive and negative electrode current collectors.

Lithium metal is a desirable negative electrode material for batteries that cycle lithium ions due to its high gravimetric and volumetric specific capacities (3,860 mAh/g and 2061 mAh/cm³, respectively) and its relatively low reduction potential (−3.04 V versus standard hydrogen electrode). When lithium metal is used as a negative electrode material in a battery that cycles lithium ions, lithium metal deposited on surfaces of the negative electrode current collectors may exhibit a mossy or dendritic structure, which may reduce the cycling efficiency of the battery. In addition, due to the low reduction potential of lithium metal, undesirable side reactions may occur at an interface between the lithium metal negative electrode and the electrolyte, which may result in decomposition of the electrolyte and the consumption of active lithium. The large volumetric changes experienced by lithium metal negative electrodes during repeated cycling may exacerbate the above scenarios.

### SUMMARY

A battery that cycles lithium ions, in accordance with one or more embodiments of the present disclosure, comprises a lithium metal negative electrode, a positive electrode, a porous separator, and a composite interlayer. The positive electrode comprises an electroactive positive electrode material and is spaced apart from the lithium metal negative electrode. The lithium metal negative electrode and the positive electrode have opposing facing surfaces. The porous separator is disposed between the opposing facing surfaces of the lithium metal negative electrode and the positive electrode. The porous separator has a first side that faces toward the lithium metal negative electrode and an opposite second side that faces toward the positive electrode. The composite interlayer is disposed on the facing surface of the lithium metal negative electrode and between the lithium metal negative electrode and the porous separator. The composite interlayer comprises a polymer matrix phase and a lithium salt distributed phase embedded in and distributed throughout the polymer matrix phase. The lithium salt distributed phase constitutes, by weight, greater than or equal to about 10% and less than or equal to about 50% of the composite interlayer.

The polymer matrix phase may comprise at least one polymer selected from the group consisting of poly(vinylidene fluoride-co-hexafluoropropylene) (PVDF-HFP), poly(ethylene oxide) (PEO), poly(acrylic acid) (PAA), poly(methyl methacrylate) (PMMA), carboxymethyl cellulose (CMC), polyacrylonitrile (PAN), polyvinylidene difluoride (PVDF), poly(vinyl alcohol) (PVA), and polyvinylpyrrolidone (PVP).

The lithium salt distributed phase may comprise at least one lithium salt selected from the group consisting of lithium bis(fluorosulfonyl)imide (LiFSI), lithium trifluoromethanesulfonate (LiOTf), lithium bis(perfluoroethane)sulfonylimide (LiBETI), lithium-cyclo-difluoromethane-1,1-bis(sulfonyl)imide (LiDMSI), and cyclo-hexafluoropropane-1,1-bis(sulfonyl)imide (LiHPSI).

The battery may further comprise an electrolyte that wets the facing surface of the lithium metal negative electrode and infiltrates the porous separator and the composite interlayer. The electrolyte may comprise an organic solvent and a lithium salt, wherein the lithium salt concentration in the electrolyte is less than the lithium salt concentration in the composite interlayer.

The electrolyte may have a lithium salt concentration of about 1 mole per liter and the composite interlayer may have a lithium salt concentration of greater than or equal to about 2 moles per cubic decimeter.

The lithium salt distributed phase may be immobilized in the polymer matrix phase of the composite interlayer such that the lithium salt distributed phase is not released from the composite interlayer when the composite interlayer is infiltrated with the electrolyte.

The composite interlayer may extend from the facing surface of the lithium metal negative electrode to the first side of the porous separator. In such case, the composite interlayer may have a thickness of greater than or equal to about 5 micrometers and less than or equal to about 50 micrometers.

The porous separator may comprise a polyolefin and may have a thickness of greater than or equal to about 5 micrometers and less than or equal to about 500 micrometers.

A battery that cycles lithium ions, in accordance with one or more embodiments of the present disclosure, comprises a lithium metal negative electrode, a positive electrode, a porous separator, a composite interlayer, and an electrolyte. The positive electrode is spaced apart from the lithium metal negative electrode and comprises an electroactive positive electrode material. The lithium metal negative electrode and the positive electrode have opposing facing surfaces. The porous separator is disposed between the opposing facing surfaces of the lithium metal negative electrode and the positive electrode. The porous separator has a first side that faces toward the lithium metal negative electrode and an opposite second side that faces toward the positive electrode. The composite interlayer is disposed on the facing surface of the lithium metal negative electrode and between the lithium metal negative electrode and the porous separator. The composite interlayer comprises a polymer matrix phase and a lithium salt distributed phase embedded in and distributed throughout the polymer matrix phase. The lithium salt distributed phase constitutes, by weight, greater than or equal to about 10% and less than or equal to about 50% of the composite interlayer. The electrolyte wets the facing surface of the lithium metal negative electrode and infiltrates the porous separator and the composite interlayer. The electrolyte comprises an organic solvent and a lithium salt. The lithium salt concentration in the electrolyte is less than the lithium salt concentration in the composite interlayer.

The polymer matrix phase may comprise poly(vinylidene fluoride-co-hexafluoropropylene) (PVDF-HFP).

The lithium salt distributed phase may comprise lithium bis(fluorosulfonyl)imide (LiFSI).

The electrolyte may have a lithium salt concentration of about 1 mole per liter. The composite interlayer may have a lithium salt concentration of greater than or equal to about 2 moles per cubic decimeter.

The lithium salt distributed phase may be immobilized in the polymer matrix phase of the composite interlayer such that the lithium salt distributed phase is not released from the composite interlayer when the composite interlayer is infiltrated with the electrolyte.

The composite interlayer may extend from the facing surface of the lithium metal negative electrode to the first side of the porous separator and may have a thickness of greater than or equal to about 5 micrometers and less than or equal to about 50 micrometers.

A method of manufacturing a battery that cycles lithium ions is disclosed. In the method, a precursor is prepared comprising an organic solvent, a polymer, and a lithium salt in the organic solvent. The precursor is deposited on a substrate to form a precursor layer thereon. Then, the organic solvent is removed from the precursor layer to form a composite interlayer comprising the polymer and the lithium salt embedded in and distributed throughout the polymer.

The lithium salt may constitute, by weight, greater than or equal to about 3% and less than or equal to about 15% of the precursor. The polymer may constitute, by weight, greater than or equal to about 15% and less than or equal to about 70% of the precursor.

The organic solvent may have a boiling point of greater than or equal to about 80 degrees Celsius and less than about 180 degrees Celsius.

The organic solvent may comprise acetonitrile (ACN), N-Methyl-2-pyrrolidone (NMP), methoxy methane (DME), dimethyl carbonate (DMC), dimethylformamide (DMF), or a combination thereof.

The substrate may be a lithium metal layer disposed on a metal current collector. In such case, the method may further comprise assembling the composite interlayer into a battery.

The substrate may be made of plastic or glass. In such case, the method may further comprise peeling the composite interlayer off the substrate, positioning the composite interlayer on a surface of a lithium metal layer, and assembling the composite interlayer and the lithium metal layer into a battery.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a negative electrode, a positive electrode, a porous separator, a composite interlayer disposed between the negative electrode and the porous separator, and an electrolyte infiltrating the positive electrode, the porous separator, and the composite interlayer.

In the drawings, reference numbers may be reused to identify similar and/or identical elements.

### DETAILED DESCRIPTION

The presently disclosed composite interlayer can be disposed on a facing surface of a lithium metal negative electrode of a battery that cycles lithium ions to improve the cycle stability thereof. The composite interlayer is electrically insulating and ionically conductive and is configured to establish a locally high lithium salt concentration along the facing surface of the lithium metal negative electrode, as compared to the lithium salt concentration in the electrolyte, which may help prevent undesirable chemical reactions from occurring between the lithium metal negative electrode and the electrolyte and may inhibit the undesirable formation of lithium dendrites. The composite interlayer can establish a high lithium salt concentration along the facing surface of the lithium metal negative electrode without significantly increasing the overall lithium salt concentration in the battery, which might otherwise increase the cost of the battery, without causing corrosion of aluminum current collectors, and without increasing the viscosity of the electrolyte.

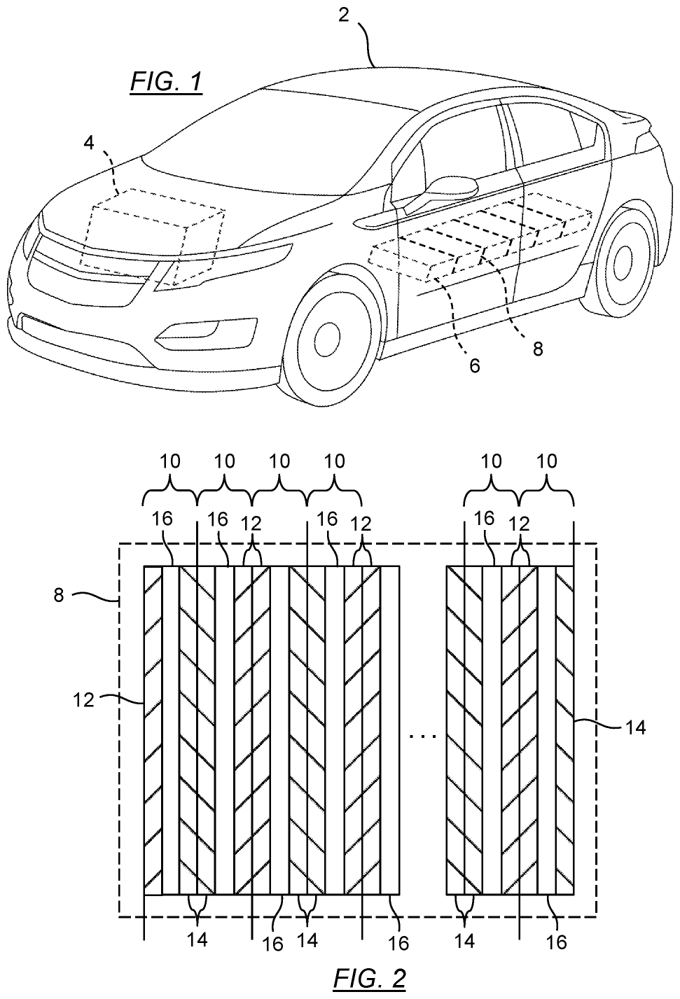

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative and positive electrode current collectors 13, 15 are double sided and include negative or positive electrode layers 12, 14 on both sides thereof. In this arrangement, adjacent negative electrode layers 12 and positive electrode layers 14 share a single negative or positive current collector 13, 15.

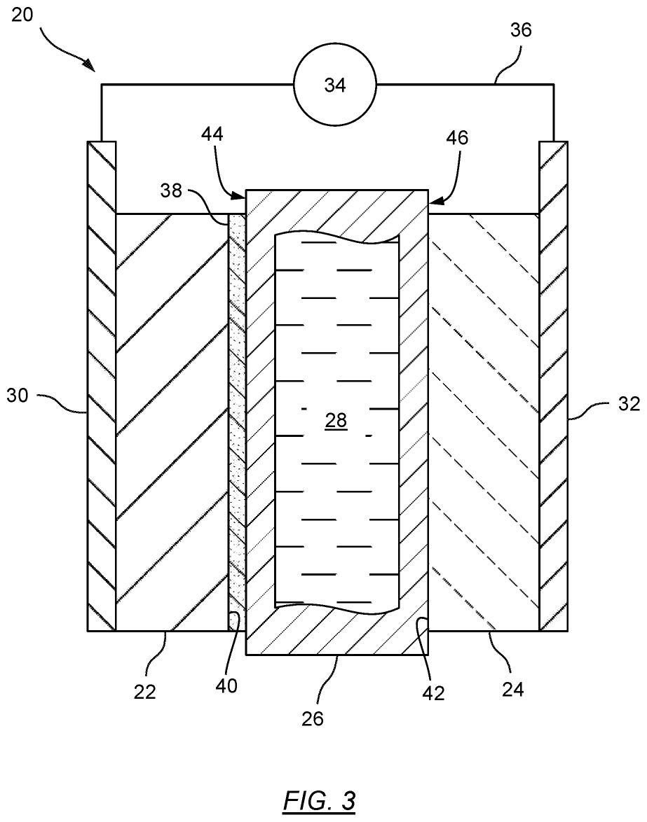

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24 spaced apart from the negative electrode 22, a separator 26, a composite interlayer 38, and an electrolyte 28. The separator 26 is disposed between a facing surface 40 of the negative electrode 22 and an opposing facing surface 42 of the positive electrode 24. The separator 26 has a first side 44 that faces toward the negative electrode 22 and an opposite second side 46 that faces away from the negative electrode 22, toward the positive electrode 24. The negative electrode 22 is disposed on a negative electrode current collector 30 and the positive electrode 24 is disposed on a positive electrode current collector 32. In practice, the negative electrode current collector 30 and the positive electrode current collector 32 are electrically coupled to a power source or load 34 (e.g., the electric motor 12) via an external circuit 36.

The negative and positive electrodes 22, 24 are formulated such that, when the battery 20 is at least partially charged, an electrochemical potential difference is established between the negative and positive electrodes 22, 24. During discharge of the battery 20, the electrochemical potential established between the negative and positive electrodes 22, 24 drives spontaneous reduction and oxidation (redox) reactions within the battery 20 and the release of lithium ions and electrons at the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative and positive electrodes 22, 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The negative electrode 22 is electrochemically active and is disposed on a major surface of the negative electrode current collector 30. The negative electrode 22 comprises lithium (Li) and may consist essentially of or consist of lithium. For example, the negative electrode 22 may comprise, by weight, greater than 97% lithium, or optionally greater than 99% lithium. The negative electrode 22 may be substantially free of elements or compounds that undergo a reversible redox reaction with lithium during operation of the battery 20. For example, the lithium metal negative electrode 22 may be substantially free of an intercalation host material that is formulated to undergo the reversible insertion or intercalation of lithium ions or an alloying material that can electrochemically alloy and form compound phases with lithium. In addition, the negative electrode 22 may be substantially free of a conversion material or an alloy material that can electrochemically alloy and form compound phases with lithium. Some examples of materials that may be intentionally excluded from the negative electrode 22 include carbon-based materials (e.g., graphite, activated carbon, carbon black, and graphene), silicon and silicon-based materials, tin oxide, aluminum, indium, zinc, cadmium, lead, germanium, tin, antimony, titanium oxide, lithium titanium oxide, lithium titanate, lithium oxide, metal oxides (e.g., iron oxide, cobalt oxide, manganese oxide, copper oxide, nickel oxide, chromium oxide, ruthenium oxide, and/or molybdenum oxide), metal phosphides, metal sulfides, and metal nitrides (e.g., phosphides, sulfides, and/or nitrides or iron, manganese, nickel, copper, and/or cobalt). The negative electrode 22 may be substantially free of a polymer binder. Some examples of polymer binders that may be intentionally excluded from negative electrode 22 include polyvinylidene fluoride (PVdF), ethylene propylene diene monomer (EPDM) rubber, styrene butadiene rubber (SBR), carboxymethyl cellulose (CMC), and polyacrylic acid.

The positive electrode 24 is formulated to store and release lithium ions during discharge and charge of the battery 20. The positive electrode 24 may be in the form of a continuous porous layer of material disposed on a major surface of the positive electrode current collector 32. The positive electrode 24 comprises an electrochemically active (electroactive) material (electroactive positive electrode material), a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material.

The electroactive material of the positive electrode 24 can store and release lithium ions by undergoing a reversible redox reaction with lithium. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a layered lithium transition metal oxide represented by the formula LiMeO₂, an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In aspects where the electroactive material of the positive electrode 24 comprises a conversion material, the electroactive material of the positive electrode 24 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof (e.g., a compound of iron, manganese, nickel, copper, and/or cobalt). The electroactive material of the positive electrode 24 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the positive electrode 24.

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to about 1%, or optionally greater than or equal to about 5%, and less than or equal to about 10% of the positive electrode 24.

The optional electrically conductive material is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to about 1%, or optionally greater than or equal to about 5% and less than or equal to about 10% of the positive electrode 24.

The separator 26 physically separates and electrically isolates the negative electrode 22 and the positive electrode 24 from each other while permitting lithium ions to pass therethrough. The separator 26 has an open microporous structure and may comprise an organic and/or inorganic material. For example, the separator 26 may comprise a polymer or a combination of polymers. For example, the separator 26 may comprise one or more polyolefins, e.g., polyethylene (PE), polypropylene (PP), polyamide (PA), poly(tetrafluoroethylene) (PTFE), polyvinylidene fluoride (PVDF), and/or poly(vinyl chloride) (PVC). In one form, the separator 26 may comprise a laminate of polymers, e.g., a laminate of PE and PP. In aspects, the separator 26 may comprise a ceramic coating (not shown) disposed on one or both sides thereof. In such case, the ceramic coating may comprise particles of alumina (Al₂O₃) and/or silica (SiO₂). The separator 26 may have a thickness of greater than or equal to about 5 micrometers (μm), optionally greater than or equal to about 10 μm, or optionally greater than or equal to about 20 μm and less than or equal to about 500 μm, optionally less than or equal to about 200 μm, or optionally less than or equal to about 50 μm. The separator 26 may have a porosity of greater than or equal to about 20%, optionally greater than or equal to about 30% and less than or equal to about 80%, or optionally less than or equal to about 70%.

The electrolyte 28 is ionically conductive and provides a medium for the conduction of lithium ions between the negative electrode 22 and the positive electrode 24. The electrolyte 28 infiltrates the positive electrode 24, the separator 26, and the composite interlayer 38 and wets the facing surface 40 of the negative electrode 22. The electrolyte 28 comprises an organic solvent and a lithium salt in the organic solvent.

The organic solvent of the electrolyte 28 may comprise a nonaqueous aprotic organic solvent. Non-limiting examples of non-aqueous aprotic organic solvents include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof. In aspects, the organic solvent may comprise a mixture of a cyclic carbonate and a linear carbonate. The organic solvent may constitute, by weight, greater than or equal to about 80%, or optionally greater than or equal to about 85%, and less than or equal to about 95%, or optionally less than or equal to about 90% of the electrolyte 28.

The lithium salt of the electrolyte 28 is soluble in the organic solvent and provides a passage for lithium ions through the electrolyte 28. The lithium salt may comprise an inorganic lithium salt, an organic lithium salt, or a combination thereof. Examples of inorganic lithium salts include lithium hexafluorophosphate (LiPF₆), lithium difluorophosphate (LiPO₂F₂), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiFSI), lithium tetraphenylborate (LiB(C₆H₅)₄), lithium bis(oxalato)borate (LiB(C₂O₄)₂) (LiBOB), lithium difluoro(oxalato)borate (LiBF₂(C₂O₄)) (LiDFOB), and combinations thereof. In aspects, the lithium salt may comprise LiPF₆. The lithium salt may be dissolved in the organic solvent at a concentration of greater than or equal to about 0.5 moles per liter (mol/L or Molar) and less than or equal to about 1.5 Molar. In aspects, the lithium salt may be dissolved in the organic solvent at a concentration of about 1 Molar. The lithium salt may constitute, by weight, greater than or equal to about 5%, optionally greater than or equal to about 10%, and less than or equal to about 20%, or optionally less than or equal to about 15% of the electrolyte 28.

The negative and positive electrode current collectors 30, 32 are electrically conductive and provide an electrical connection between the external circuit 36 and their respective negative and positive electrodes 22, 24. In aspects, the negative and positive electrode current collectors 30, 32 may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (AI) or another appropriate electrically conductive material.

The composite interlayer 38 is electrically insulating and ionically conductive and is configured to help prevent undesirable chemical reactions from occurring between the electrolyte 28 and the negative electrode 22 without impeding the flow of lithium ions between the electrolyte 28 and the negative electrode 22. The composite interlayer 38 has an open microporous structure and is disposed on the facing surface 40 of the negative electrode 22, between the negative electrode 22 and the first side 44 of the separator 26. The composite interlayer 38 may have a porosity of greater than or equal to about 20%, optionally greater than or equal to about 30% and less than or equal to about 80%, or optionally less than or equal to about 70%. The composite interlayer 38 comprises a polymer matrix phase and a lithium salt distributed phase embedded in and distributed substantially homogenously throughout the polymer matrix phase of the composite interlayer 38.

The polymer matrix phase is configured to provide the composite interlayer 38 with good mechanical strength and flexibility and to help retain, trap, or immobilize the lithium salt distributed phase in the composite interlayer 38. The polymer matrix phase comprises a polymer. For example, the polymer matrix phase may comprise poly(vinylidene fluoride-co-hexafluoropropylene) (PVDF-HFP), poly(ethylene oxide) (PEO), poly(acrylic acid) (PAA), poly(methyl methacrylate) (PMMA), carboxymethyl cellulose (CMC), polyacrylonitrile (PAN), polyvinylidene difluoride (PVDF), poly(vinyl alcohol) (PVA), polyvinylpyrrolidone (PVP), or a combination thereof. The polymer matrix phase may constitute, by weight, greater than or equal to about 50% and less than or equal to about 90% of the composite interlayer 38.

The lithium salt distributed phase comprises a lithium salt and provides the composite interlayer 38 with a relatively high concentration of lithium salt, as compared to the lithium salt concentration in the rest of the battery 20, e.g., within the electrolyte 28. The lithium salt distributed phase is entrapped or immobilized in the polymer matrix phase of the composite interlayer 38 such that the lithium salt distributed phase will not be dissolved in or released from the composite interlayer 38 when the composite interlayer 38 is infiltrated with the electrolyte 28. The lithium salt of the lithium salt distributed phase may comprise lithium bis(fluorosulfonyl)imide (LiN(FSO₂)₂) (LiFSI), lithium trifluoromethanesulfonate (LiCF₃SO₃) (LiOTf), lithium bis(perfluoroethane)sulfonylimide (Li(CF₃CF₂SO₂)₂N) (LiBETI), lithium-cyclo-difluoromethane-1,1-bis(sulfonyl)imide (LiDMSI), cyclo-hexafluoropropane-1,1-bis(sulfonyl)imide (LiHPSI), or a combination thereof. The lithium salt distributed phase may comprise the same lithium salt or a different lithium salt than that included in the electrolyte 28.

The lithium salt distributed phase may constitute, by weight, greater than or equal to about 10%, optionally greater than or equal to about 15%, optionally greater than or equal to about 20%, optionally greater than or equal to about 25%, optionally greater than or equal to about 30%, optionally greater than or equal to about 35%, optionally greater than or equal to about 40%, or optionally greater than or equal to about 45% and less than or equal to about 50% of the composite interlayer 38. The concentration of the lithium salt distributed phase in the composite interlayer 38 may be greater than or equal to about 1 mole per cubic decimeter (mol/dm³), optionally greater than or equal to about 1.5 mol/dm³, optionally greater than or equal to about 2 mol/dm³, optionally greater than or equal to about 2.5 mol/dm³, optionally greater than or equal to about 3 mol/dm³, optionally greater than or equal to about 3.5 mol/dm³, optionally greater than or equal to about 4 mol/dm³, or optionally greater than or equal to about 4.5 mol/dm³ and less than or equal to about 10 mol/dm³.

The lithium salt distributed phase in the composite interlayer 38 creates a locally high lithium salt concentration along the facing surface 40 of the negative electrode 22, as compared to the lithium salt concentration in the electrolyte 28. In other words, the lithium salt concentration in the composite interlayer 38 is greater than the lithium salt concentration in the electrolyte 28. In turn, the lithium salt concentration in the composite interlayer 38 is also greater than the lithium salt concentration in the separator 26 infiltrated with the electrolyte 28. Without intending to be bound by theory, it is believed that creating a locally high lithium salt concentration along the facing surface 40 of the negative electrode 22 may increase the number of organic solvent molecules in the electrolyte 28 along the facing surface 40 of the negative electrode 22 that are coordinated to lithium ions (Li+), thereby reducing the number of free organic solvent molecules in the electrolyte 28 that can be reduced at the negative electrode 22.

The composite interlayer 38 creates a mechanically robust interphase between the negative electrode 22 and the electrolyte 28 that helps prevent undesirable reactions from occurring between the negative electrode 22 and the electrolyte 28 during repeated cycling of the battery 20. In addition, the interphase established between the negative electrode 22 and the electrolyte 28 by the composite interlayer 38 can be maintained during repeated cycling of the battery 20 without resulting in the undesirable consumption of the electrolyte 28 and/or the undesirable consumption of active lithium in the battery 20, which can increase the cycle life of the battery 20. In addition, without intending to be bound by theory, it is believed that the composite interlayer 38 may help suppress the formation of lithium dendrites on the facing surface 40 of the negative electrode 22, for example, by creating a robust physical barrier that hinders growth of lithium dendrites at or on the negative electrode 22. In addition, it is believed that the composite interlayer 38 may help promote the uniform deposition of lithium metal on the negative electrode current collector 30.

### Methods

The composite interlayer 38 may be manufactured by depositing a precursor solution on a substrate to form a precursor layer, and then drying the precursor layer.

The precursor solution may comprise an organic solvent, a polymer, and a lithium salt dissolved in the organic solvent. The polymer in the precursor solution may have substantially the same composition as that of the polymer matrix phase in the composite interlayer 38 and may constitute, by weight, greater than or equal to about 15% and less than or equal to about 70% of the precursor solution. The lithium salt in the precursor solution may have substantially the same composition as that of the lithium salt distributed phase in the composite interlayer 38 and may constitute, by weight, greater than or equal to about 3%, or optionally greater than or equal to about 5% and less than or equal to about 15%, or optionally less than or equal to about 10% of the precursor solution. The organic solvent in the precursor solution may have a boiling point of greater than or equal to about 80 degrees Celsius and less than about 180 degrees Celsius. Examples of organic solvents having boiling points in this range include acetonitrile (ACN), N-Methyl-2-pyrrolidone (NMP), methoxy methane (DME), dimethyl carbonate (DMC), dimethylformamide (DMF), or a combination thereof. The organic solvent may constitute, by weight, greater than or equal to about 20% and less than or equal to about 80% of the precursor solution.

In aspects, the substrate may be made of plastic or glass. For example, the substrate may be made of polyethylene terephthalate (PET). In other aspects, the substrate may comprise the same material as that of the negative electrode 22.

The precursor solution may be deposited on the substrate via any suitable method. For example, the precursor solution may be deposited on the substrate using a tape casting technique.

After the precursor layer is formed on the substrate, the organic solvent is removed from the precursor layer to form the composite interlayer 38. The organic solvent may be removed from the precursor layer, for example, by evaporation. For example, the organic solvent may be removed from the precursor layer by heating the precursor layer at a temperature of about 60 degrees Celsius for about 12 hours to evaporate the organic solvent therefrom.

In aspects where the substrate comprises the same material as that of the negative electrode 22, the substrate and the composite interlayer 38 may be combined with other necessary components and assembled into a battery 20. In aspects where the substrate is made of plastic or glass, the composite interlayer 38 may be peeled off of the substrate. Then, the composite interlayer 38 may be positioned on or applied to a surface of a lithium metal layer and assembled into a battery 20, wherein the lithium metal layer may define the negative electrode 22.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A battery that cycles lithium ions, the battery comprising:
a lithium metal negative electrode;
a positive electrode spaced apart from the lithium metal negative electrode, the positive electrode comprising an electroactive positive electrode material, the lithium metal negative electrode and the positive electrode having opposing facing surfaces;
a porous separator disposed between the opposing facing surfaces of the lithium metal negative electrode and the positive electrode, the porous separator having a first side that faces toward the lithium metal negative electrode and an opposite second side that faces toward the positive electrode; and
a composite interlayer disposed on the facing surface of the lithium metal negative electrode and between the lithium metal negative electrode and the porous separator, the composite interlayer comprising:
a polymer matrix phase, and
a lithium salt distributed phase embedded in and distributed throughout the polymer matrix phase, the lithium salt distributed phase constituting, by weight, greater than or equal to about 10% and less than or equal to about 50% of the composite interlayer.

2. The battery of claim 1, wherein the polymer matrix phase comprises at least one polymer selected from the group consisting of poly(vinylidene fluoride-co-hexafluoropropylene) (PVDF-HFP), poly(ethylene oxide) (PEO), poly(acrylic acid) (PAA), poly(methyl methacrylate) (PMMA), carboxymethyl cellulose (CMC), polyacrylonitrile (PAN), polyvinylidene difluoride (PVDF), poly(vinyl alcohol) (PVA), and polyvinylpyrrolidone (PVP).

3. The battery of claim 1, wherein the lithium salt distributed phase comprises at least one lithium salt selected from the group consisting of lithium bis(fluorosulfonyl)imide (LiFSI), lithium trifluoromethanesulfonate (LiOTf), lithium bis(perfluoroethane)sulfonylimide (LiBETI), lithium-cyclo-difluoromethane-1,1-bis(sulfonyl)imide (LiDMSI), and cyclo-hexafluoropropane-1,1-bis(sulfonyl)imide (LiHPSI).

4. The battery of claim 1, further comprising:
an electrolyte that wets the facing surface of the lithium metal negative electrode and infiltrates the porous separator and the composite interlayer, the electrolyte comprising an organic solvent and a lithium salt, wherein the lithium salt concentration in the electrolyte is less than the lithium salt concentration in the composite interlayer.

5. The battery of claim 4, wherein the electrolyte has a lithium salt concentration of about 1 mole per liter, and wherein the composite interlayer has a lithium salt concentration of greater than or equal to about 2 moles per cubic decimeter.

6. The battery of claim 4, wherein the lithium salt distributed phase is immobilized in the polymer matrix phase of the composite interlayer such that the lithium salt distributed phase is not released from the composite interlayer when the composite interlayer is infiltrated with the electrolyte.

7. The battery of claim 1, wherein the composite interlayer extends from the facing surface of the lithium metal negative electrode to the first side of the porous separator, and wherein the composite interlayer has a thickness of greater than or equal to about 5 micrometers and less than or equal to about 50 micrometers.

8. The battery of claim 7, wherein the porous separator comprises a polyolefin and has a thickness of greater than or equal to about 5 micrometers and less than or equal to about 500 micrometers.

9. A battery that cycles lithium ions, the battery comprising:
a lithium metal negative electrode;
a positive electrode spaced apart from the lithium metal negative electrode, the positive electrode comprising an electroactive positive electrode material, the lithium metal negative electrode and the positive electrode having opposing facing surfaces;
a porous separator disposed between the opposing facing surfaces of the lithium metal negative electrode and the positive electrode, the porous separator having a first side that faces toward the lithium metal negative electrode and an opposite second side that faces toward the positive electrode;
a composite interlayer disposed on the facing surface of the lithium metal negative electrode and between the lithium metal negative electrode and the porous separator, the composite interlayer comprising a polymer matrix phase and a lithium salt distributed phase embedded in and distributed throughout the polymer matrix phase, the lithium salt distributed phase constituting, by weight, greater than or equal to about 10% and less than or equal to about 50% of the composite interlayer; and
an electrolyte that wets the facing surface of the lithium metal negative electrode and infiltrates the porous separator and the composite interlayer, the electrolyte comprising an organic solvent and a lithium salt,
wherein the lithium salt concentration in the electrolyte is less than the lithium salt concentration in the composite interlayer.

10. The battery of claim 9, wherein the polymer matrix phase comprises poly(vinylidene fluoride-co-hexafluoropropylene) (PVDF-HFP).

11. The battery of claim 9, wherein the lithium salt distributed phase comprises lithium bis(fluorosulfonyl)imide (LiFSI).

12. The battery of claim 9, wherein the electrolyte has a lithium salt concentration of about 1 mole per liter, and wherein the composite interlayer has a lithium salt concentration of greater than or equal to about 2 moles per cubic decimeter.

13. The battery of claim 9, wherein the lithium salt distributed phase is immobilized in the polymer matrix phase of the composite interlayer such that the lithium salt distributed phase is not released from the composite interlayer when the composite interlayer is infiltrated with the electrolyte.

14. The battery of claim 9, wherein the composite interlayer extends from the facing surface of the lithium metal negative electrode to the first side of the porous separator, and wherein the composite interlayer has a thickness of greater than or equal to about 5 micrometers and less than or equal to about 50 micrometers.

15. A method of manufacturing a battery that cycles lithium ions, the method comprising:
preparing a precursor comprising an organic solvent, a polymer, and a lithium salt in the organic solvent;
depositing the precursor on a substrate to form a precursor layer thereon; and
removing the organic solvent from the precursor layer to form a composite interlayer comprising the polymer and the lithium salt embedded in and distributed throughout the polymer.

16. The method of claim 15, wherein the lithium salt constitutes, by weight, greater than or equal to about 3% and less than or equal to about 15% of the precursor, and wherein the polymer constitutes, by weight, greater than or equal to about 15% and less than or equal to about 70% of the precursor.

17. The method of claim 15, wherein the organic solvent has a boiling point of greater than or equal to about 80 degrees Celsius and less than about 180 degrees Celsius.

18. The method of claim 15, wherein the organic solvent comprises acetonitrile (ACN), N-Methyl-2-pyrrolidone (NMP), methoxy methane (DME), dimethyl carbonate (DMC), dimethylformamide (DMF), or a combination thereof.

19. The method of claim 15, wherein the substrate is a lithium metal layer disposed on a metal current collector, and wherein the method further comprises assembling the composite interlayer into a battery.

20. The method of claim 15, wherein the substrate is made of plastic or glass, and wherein the method further comprises peeling the composite interlayer off the substrate, positioning the composite interlayer on a surface of a lithium metal layer, and assembling the composite interlayer and the lithium metal layer into a battery.
